(19) United States
(12) Patent Application Publication
(10) Pub. No.: US 2020/0296891 A1
(43) Pub. Date: Sep. 24, 2020

(54) ERGONOMIC ATTACHMENT DEVICES AND SYSTEMS FOR HANDHELD TOOLS

(71) Applicant: JEWGENT, INC., Sarasota, FL (US)

(72) Inventor: LONNIE BOHRER, Sarasota, FL (US)

(73) Assignee: JEWGENT, INC., Sarasota, FL (US)

(21) Appl. No.: 16/824,926

(22) Filed: Mar. 20, 2020

Related U.S. Application Data
(60) Provisional application No. 62/821,565, filed on Mar. 21, 2019.

(51) Int. Cl. A01D 34/90; B25F 5/02

(52) U.S. Cl. CPC A01D 34/902; B25F 5/02

(57) ABSTRACT

An attachment for a tool having an elongated shaft including a generally S-shaped arm member including an elongated handle; and an attachment configured to pivotably couple the generally S-shaped arm member to the elongated shaft, wherein when the generally S-shaped arm member is coupled to the elongated shaft, the generally S-shaped arm member is configured to transition between a folded state in which the elongated handle is generally parallel relative to a longitudinally extending axis of the elongated shaft and an operable state in which an axis extending lengthwise along the elongated handle is orthogonal relative to the elongated shaft. A system including a gardening tool and the attachment is also disclosed.

### CROSS REFERENCE TO RELATED APPLICATIONS

This application relates to, and claims priority from, U.S. Prov. Pat. No. 62/821,565, filed on Mar. 21, 2019, the entire contents of which are incorporated herein by reference.

### BACKGROUND OF THE INVENTION

### Field of the Invention

The present invention generally relates to an ergonomic attachment for an elongated tool, and more particularly to a foldable attachment for an elongated stick-type gardening tool to facilitate a more ergonomic way to hold the gardening tool.

### Description of the Related Art

Gardening and lawnmowing often involve the use of specialized machinery, such as, handheld stick equipment (e.g., string trimmers, edgers, and shaft hedge trimmers). In FIG. 1, a gardener G is shown holding a gardening tool 10, which may be a string trimmer. The gardening tool 10 may include an elongated shaft having a longitudinally extending axis A-A onto which the gardener places his right hand H1 and left hand H2 along the same axis A-A to grasp and manipulate the gardening tool 10 during use. To grasp the tool 10 with both hands H1, H2 along the same axis A-A, a twisting motion of the spine is needed which may be uncomfortable as it might twist the spine to the point of strain and in some individuals (e.g., those with osteoporosis) might increase the chance of breaking a bone in the spine.

Ideally, to minimize strain on one's spine, when walking or standing, a person has both feet pointing straight ahead with his knees also facing forward. However, using a conventional stick gardening tool equipment such as the gardening tool 10, during use, the spine in necessarily twisted which may be uncomfortable and might ultimately lead to injury from the prolonged and repeated stress and strain on the spine.

The presently disclosure addresses the above discussed disadvantages of the conventional art.

### ASPECTS AND SUMMARY OF THE INVENTION

An ergonomic attachment for a tool may include an elongated shaft including a generally S-shaped arm member including an elongated handle; and an attachment configured to pivotably couple the generally S-shaped arm member to the elongated shaft, wherein when the generally S-shaped arm member is coupled to the elongated shaft, the generally S-shaped arm member is configured to transition between a folded state in which the elongated handle is generally parallel relative to a longitudinally extending axis of the elongated shaft and an operable state in which an axis extending lengthwise along the elongated handle is orthogonal relative to the elongated shaft.

An ergonomic attachment for a gardening tool may include an elongated shaft that includes a generally S-shaped arm member that includes a first portion including a first end and a second portion that is an elongated handle; and an attachment that couples the first portion to the elongated shaft. The elongated shaft may have a first longitudinally extending axis and the elongated handle has a second longitudinally extending axis, an orthogonally extending axis that is orthogonal relative to the first longitudinally extending axis being parallel relative to the a second longitudinally extending axis, the second longitudinally extending axis being spaced apart from the orthogonally extending axis. The attachment may pivotably couple the generally S-shaped arm member to the elongated shaft. The generally S-shaped arm member is configured to transition between a folded state in which the elongated handle is generally parallel relative to a longitudinally extending axis of the elongated shaft and an operable state in which an axis extending lengthwise along the elongated handle is orthogonal relative to the elongated shaft. The attachment may be releasably coupled to the elongated shaft. The attachment may be configured to pivot the generally S-shaped attachment between a folded condition and a deployed condition.

A gardening system may include a gardening tool and the disclosed ergonomic attachment.

These and other aspects of the present disclosure are more fully described hereinbelow with reference to the accompanying figures.

### BRIEF DESCRIPTION OF THE DRAWINGS

FIG. 1 is an illustration of a gardener using a conventional string trimmer.

FIG. 2 is a front view of a holding attachment shown coupled to a gardening tool and shown in an operational state.

FIG. 3 is a front view of the holding attachment shown coupled to a gardening tool and shown in a folded state.

FIG. 4 is a side view of the holding attachment shown coupled to the gardening tool of FIG. 2 and shown during use.

FIG. 5 is a perspective view of a user using the holding attachment while it is coupled to the gardening tool as shown in FIG. 2.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale.

Generally, the present disclosure relates to an ergonomic attachment for an elongated tool, and more particularly to a foldable attachment for an elongated stick-type gardening tool to facilitate a more ergonomic way to hold the gardening tool.

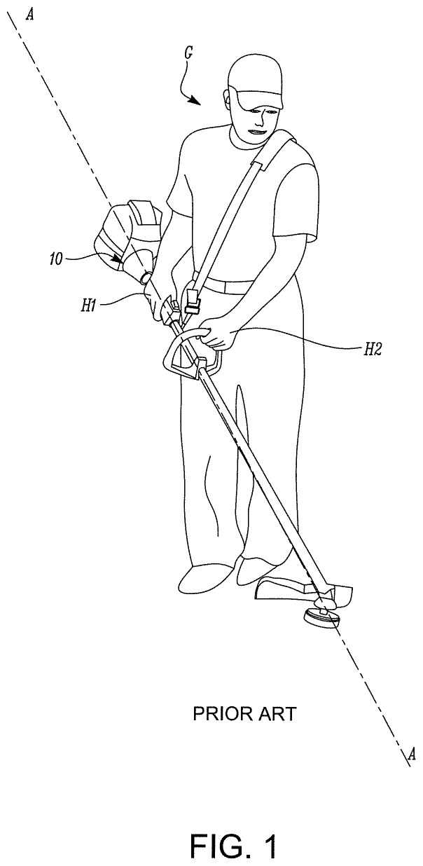

As discussed above, ideally, to minimize strain on one's spine, when walking or standing, a person has both feet pointing straight ahead with his knees also facing forward. However, using a conventional stick gardening tool equipment such as the gardening tool 10, during use, the spine in necessarily twisted which may be uncomfortable and might ultimately lead to injury from the prolonged and repeated stress and strain on the spine. However, as shown in FIG. 1, conventional stick-type gardening tools require an operator or gardener G to stand with one's spine in a twisted position so that both the left and right hands can be placed on the linearly extending shaft of the tool along the same axis A-A. The presently disclosed system 100 and attachment 110 allows for a more ergonomic way in which such tools can be held so that a more natural posture may be maintained during operation of the equipment.

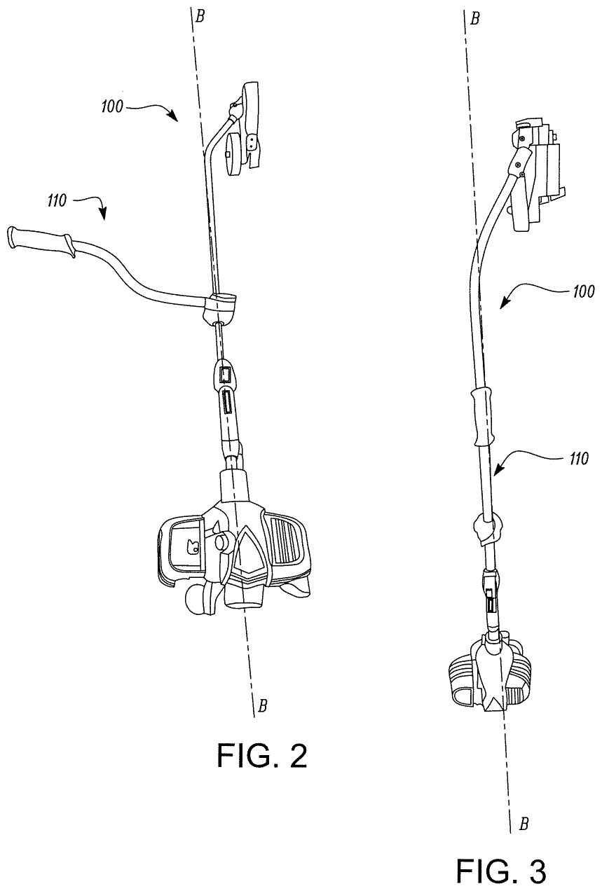

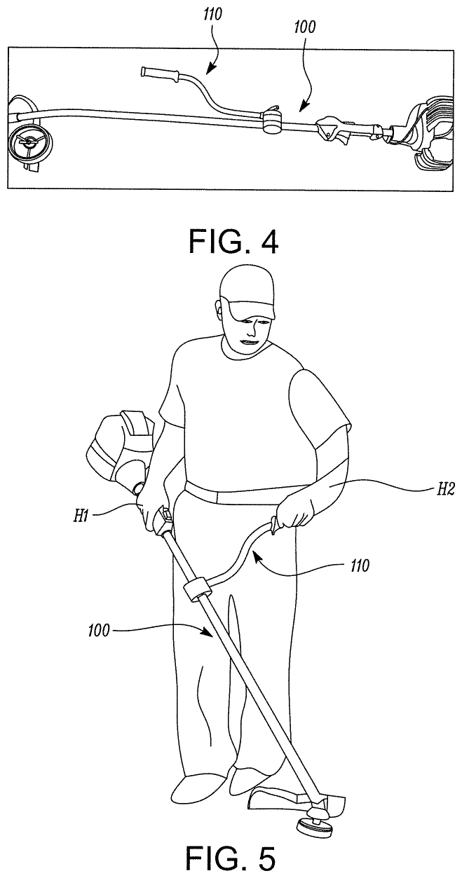

A gardening system 100 including an ergonomic handle attachment 110 is shown in FIGS. 2-4. In FIG. 2, the system 100 is shown in an operable state and in FIGS. 3-4, the system 100 is shown in a collapsed folded state that facilitates storage of the system 100.

The attachment 110 may have a generally S-shaped shape and configuration. However, other shapes of the attachment 110 are within the scope and spirit of the present disclosure and the present disclosure is not limited to any particular shape. The attachment 110 includes a distal end onto which a user may grasp the attachment 110 and a proximal end that is pivotably coupled to the elongated shaft of the gardening tool, e.g., a string trimmer. The S-shape of the attachment 110 may facilitate better posture of the gardener G by permitting the gardener G to grasp the attachment at a higher level without having to slouch or curve the spine.

When in the operative state (FIG. 2), the attachment 110 may be generally orthogonal or preferably perpendicular to the longitudinally extending axis B-B of the shaft of the gardening tool and when in the storing state (FIGS. 3-4), the attachment 110 may be folded such that the attachment 110 is generally along a parallel axis to that of the longitudinally extending axis B-B of the gardening tool.

The attachment 110 may be secured to the elongated shaft of the tool and any position or orientation of the attachment relative to the elongated shaft of the tool on which the attachment 110 is disposed may be set by the user including relative orientations of the attachment 110 between one in which the attachment 110 is generally aligned with the lengthwise axis of the tool and is perpendicular thereto.

In addition, the position of the attachment 110 along the length of the elongated shaft may also be set as desired. A screw knob, for example, may be turned in a first direction to secure the position of the attachment 110 to the elongated shaft of the tool and may be turned in a second, opposite direction to allow for further adjustments. The attachment 110 may be releasably secured to the gardening equipment. For example, a bracket that is secured via a screw and a nut may be used to secure the attachment 110 to the elongated shaft of the tool and a the attachment 110 may be free to pivot relative to the elongated shaft until the knob secured to the nut and screw is rotated sufficiently to bring the nut in closer proximity to the bracket to impede any further relative movement. However, other suitable attachment means may be utilized without deviating from the scope and spirit of the present disclosure.

While the attachment 110 has been described as being secured to a shaft or cylinder of the gardening equipment or tool, other attachment locations and means are within the scope and spirit of the present disclosure. For example, the attachment 110 may be secured to any surface of the gardening equipment or tool, for example, via any suitable fastener or adhesive or magnetic means.

As shown in FIG. 5, during use, the attachment 110 in in the operative state of FIGS. 2 and 3) and is generally orthogonal or perpendicular relative to the longitudinally extending axis of the tool's elongated shaft such that one hand, e.g., left hand H2 of the gardener, may be gripping the distal end or handle of the attachment 110 and the other hand, e.g., right hand, may be somewhere along the shaft of the tool such that the tool does not rotate. Advantageously, as compared to the conventional art as shown in FIG. 1, the hands H1 and H2 can be at the same relative height and not one in front of the other along the length of the elongated shaft of the tool, thereby facilitating better posture and minimizing twisting of the gardener's spine.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. An ergonomic attachment for a gardening tool having an elongated shaft, comprising:
a generally S-shaped arm member that includes a first portion including a first end and a second portion that is an elongated handle; and
an attachment that couples the first portion to the elongated shaft,
wherein the elongated shaft has a first longitudinally extending axis and the elongated handle has a second longitudinally extending axis, an orthogonally extending axis that is orthogonal relative to the first longitudinally extending axis being parallel relative to the a second longitudinally extending axis, the second longitudinally extending axis being spaced apart from the orthogonally extending axis.

2. The ergonomic attachment of claim 1, wherein:
the attachment pivotably couples the generally S-shaped arm member to the elongated shaft.

3. The ergonomic attachment of claim 2, wherein:
the generally S-shaped arm member is configured to transition between a folded state in which the elongated handle is generally parallel relative to a longitudinally extending axis of the elongated shaft and an operable state in which an axis extending lengthwise along the elongated handle is orthogonal relative to the elongated shaft.

4. The ergonomic attachment of claim 1, wherein:
the attachment is releasably coupled to the elongated shaft.

5. The ergonomic attachment of claim 1, wherein:
the attachment is configured to pivot the generally S-shaped attachment between a folded condition and a deployed condition.

6. A gardening tool system, comprising:
a gardening tool;
an ergonomic attachment for the gardening tool having an elongated shaft, comprising:
a generally S-shaped arm member that includes a first portion including a first end and a second portion that is an elongated handle; and
an attachment that couples the first portion to the elongated shaft,
wherein the elongated shaft has a first longitudinally extending axis and the elongated handle has a second longitudinally extending axis, an orthogonally extending axis that is orthogonal relative to the first longitudinally extending axis being parallel relative to the a second longitudinally extending axis, the second longitudinally extending axis being spaced apart from the orthogonally extending axis.

7. The gardening tool system of claim 6, wherein:
the attachment pivotably couples the generally S-shaped arm member to the elongated shaft.

8. The gardening tool system of claim 6, wherein:
the generally S-shaped arm member is configured to transition between a folded state in which the elongated handle is generally parallel relative to a longitudinally extending axis of the elongated shaft and an operable state in which an axis extending lengthwise along the elongated handle is orthogonal relative to the elongated shaft.

9. The gardening tool system of claim 6, wherein:
the attachment is releasably coupled to the elongated shaft.

10. The gardening tool system of claim 6, wherein:
the attachment is configured to pivot the generally S-shaped attachment between a folded condition and a deployed condition.
